(19) United States
(12) Patent Application Publication
(10) Pub. No.: US 2020/0109086 A1
(43) Pub. Date: Apr. 9, 2020

(54) METHOD FOR MANUFACTURING CEMENT

(71) Applicant: Ravi Kant AHALAWAT, Faridabad (IN)

(72) Inventor: Ravi Kant AHALAWAT, Faridabad (IN)

(21) Appl. No.: 16/617,748

(22) PCT Filed: May 28, 2018
(86) PCT No.: PCT/IN2018/050337

§ 371 Date: Nov. 27, 2019

(30) Foreign Application Priority Data
May 29, 2017 (IN) 201711018874

(51) Int. Cl. C04B 7/52; C04B 7/44; C04B 7/36; C04B 28/02

(52) U.S. Cl. CPC C04B 7/52; C04B 28/02; C04B 7/362; C04B 7/44

(57) ABSTRACT

The present invention pertains to a method for manufacturing cement, wherein the gypsum is first calcined separately before being inter-grinded with the clinker so as to minimize the release of water of crystallization of during the inter-grinding stage. The method produces cement of high strength at all ages, better rheology, enables higher use of fly ash, and reduces CO₂ emission during manufacturing.

### RELATED APPLICATION INFORMATION

This patent claims priority from International PCT Patent Application No. PCT/IN2018/050337, filed May 28, 2018 entitled, “METHOD FOR MANUFACTURING CEMENT”, which claims priority to Indian Application No. 201711018874, filed May 29, 2017 entitled, “METHOD FOR MANUFACTURING CEMENT”, which are incorporated herein by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The present invention relates to a method for manufacturing cement. In particular, the present method pertains to method of manufacturing cement by inter-grinding a pre-treated gypsum with clinker to minimize the loss of water of crystallization during the intergrinding stage. The cement manufactured in accordance with the present invention has, amongst other benefits, high strength, better rheology, and lower emission of carbon dioxide

### BACKGROUND

Many different processes for manufacturing different types of cement are known across the world. Usually, the process for manufacturing common Portland cement starts with manufacturing clinker either by dry process or wet process. Presently, dry process is the major method adopted worldwide to produce clinker. Two types of Portland clinker are produced—grey and white. Grey clinker is manufactured by heating grounded raw materials such as limestone (CaCO₃), silica sand (SiO₂), aluminum oxide (Al₂O₃) from bauxite or clay, shale and iron oxide (Fe₂O₃) in a rotary kiln at a sintering temperature of around 1450° C. to produce grayish nodules, a hydraulic compound known as clinker. Aluminum oxide and iron oxide act as flux materials to reduce the sintering temperature in kiln. Whereas in production of white clinker the iron oxide is kept as minimum as possible and aluminum oxide is the major flux material available resulting in higher sintering temperature of around 1550° C. (centigrade) in kiln.

Different types of Portland cement are produced by inter grinding of clinker with gypsum and other raw materials such as fly ash, slag, volcanic ash, rice husk ash, meta kaolin, silica fume, limestone and the like. There are four major types of Portland cement produced:

1. OPC Grey (Ordinary Portland Cement, Grey)

2. OPC White (Ordinary Portland Cement, White)

3. PPC (Portland Pozzolana Cement)

4. PSC (Portland Slag Cement)

The Portland clinker is majorly composed of following four phases:

a) C₃S (Tri Calcium Silicate), Alite

b) C2S (Di Calcium Silicate), Belite

c) C3A (Tri Calcium Aluminate)

d) C4AF (Tetra Calcium Alumino-ferrite)

Irrespective of the type of Portland cement and addition of pozzolans, slag or any performance improver or grinding aid, if Portland clinker is finely grounded without gypsum to produce cement, then on addition of water the C₃A of cement reacts rapidly with water in an exothermic reaction to form calcium aluminate hydrate inducing flash set of cement paste within minutes. The other phases, especially C₃S, also contribute in reactions leading to flash set. To prevent this phenomenon of flash set and keep the cement paste workable for few hours, clinker is first grounded with gypsum (CaSO₄.2H₂O; calcium sulfate dihydrate) to produce different types of Portland cement.

C₃A is a highly reactive phase and it rapidly reacts with water in a highly exothermic reaction to form calcium aluminate hydrate. In presence of calcium sulfate, however, C₃A undergoes a different hydration reaction, wherein it reacts with calcium sulfate in pore solution to form calcium sulfoaluminate compound known as ettringite during early hydration. The prior art suggests several theories regarding the mechanism by which C₃A hydration and hence clinker grain hydration is slowed down in presence of calcium sulfate. It is usually controlled by either diffusion through a hydrate layer such as formation of a coating of ettringite crystals on clinker grains, or by the adsorption of calcium and/or sulfate ions on clinker grains while decreasing the dissolution rate of C₃A blocking active sites.

Either way, the reaction between calcium sulfate and C₃A slows down the hydration of C₃A and as a result the hydration of cement grains for some time (which is called dormant period) and allows preparing a workable cement paste. Though some calcium aluminate hydrate does form initially, but it immediately reacts with calcium sulfate in solution to form ettringite as well. The reaction between calcium sulfate and C₃A immediately slows down further rapid hydration of C₃A and clinker grains for some time and allows a dormant period during which cement paste remains workable. The addition of gypsum is known since the Portland cement was invented. Gypsum or a mixture of gypsum and natural anhydrite is a major ingredient in mostly all forms of grey and white Portland cements.

### DRAWBACKS IN PRIOR ART

Depending on type of cement, namely whether it is OPC, PPC or PSC, natural mineral gypsum or marine gypsum or synthetic gypsum etc. or their mixture, sometimes along with small percentage of natural anhydrite is added to the clinker at the final grinding stage of cement along with fly ash (in PPC) or slag (in PSC).

During the final inter grinding process of clinker with gypsum (and other raw materials like fly ash or slag or other pozzolans or limestone etc., which are added based on type of cement and other requirements) in large scale grinding mills at cement manufacturing plant, the mechanical energy gets transformed into heat due to which the temperature of grinding mill and raw materials in the mill rises. The mill temperature is ideally maintained around 100°˜110° centigrade. Two types of plants being used by cement manufacturers to produce cement:
1. Integrated units, where production of clinker and final stage inter grinding of clinker with gypsum and other raw materials (like fly ash or slag, which are added optionally based on type of cement) is carried out in the common unit.
2. Grinding units, where only final stage inter grinding of clinker with gypsum and other raw materials is carried out. In grinding units, the clinker is manufactured separately and transported separately.

The mill temperature in integrated units is usually higher than the grinding units because the clinker used in integrated units is fresh from the line and hot, whereas in grinding units clinker cools down during transportation and usually found at ambient temperature.

Gypsum (CaSO₄.2H₂O) has two molecules of water of crystallization. At normal pressure and around 50° C. the gypsum starts dehydrating and loose its water of crystallization in the form of water vapors. At around 110° C., gypsum loses one and a half molecule of water and transforms into hemihydrate (CaSO₄.½H₂O). It continues to lose further remaining half molecule of water up to 150° centigrade; and around 150° to 180° centigrade the hemihydrate coverts into soluble anhydrite (CaSO₄). On further heating, say above 350° C., gypsum changes into insoluble anhydrite.

During an ideal inter-grinding process, gypsum starts attaching itself on the surface of clinker and as the size of raw clinker and raw gypsum keep reducing, gypsum particle and clinker particle keep coming closer to each other because of good affinity towards each other, even though in presence of other raw materials. By the time grinding is completed and cement is manufactured of a desired fineness, the finally reduced clinker particle and gypsum particle are packed with each other in perfect manner. This phenomenon occurs only if inter-grinding takes place at low temperatures or in other words if the temperature of mill and raw materials is kept under 40° C. during grinding. If the grinding takes place at higher temperatures, like it happens in large scale grinding mills in cement manufacturing plant (where temperature of mill can even reach 150° C. if not controlled by proper means), the continuously reducing gypsum particle starts dehydrating and keep losing water of crystallization in form of water vapors of high temperature or even steam during whole grinding process. Thus, during grinding at elevated temperatures, three actions are taking place in parallel: (i) reduction in size of clinker and gypsum particles; (ii) the phenomenon of coming closer of clinker and gypsum particles; and (iii) generation of water vapors of high temperature or steam from continuous de-hydration of gypsum particle. The degree of dehydration of gypsum will depend on various factors like: a) Temperature of grinding mill maintained during whole grinding process, b) Methods adopted for controlling mill temperature, c) Temperature of clinker at the time of feeding, d) Time period for which gypsum is exposed to high temperature during grinding process, etc.

The clinker particle and gypsum particle have very good affinity towards each other and if their inter grinding takes place at temperature less than 40° C. (like it mostly happens in laboratory scale ball mill), both are packed with each other in perfect manner. But the generation of water vapors of high temperature or steam from dehydrating gypsum during inter grinding process with clinker and other raw materials (which are added optionally based on type of cement and other requirements) at higher temperatures leads to few basic problems as described below:
1. In large scale grinding mills, during inter grinding process of clinker with gypsum and other raw materials, at elevated temperature the closely attached gypsum particle with clinker particle will keep losing its water of crystallization in form of water vapors of high temperature or steam. These water vapors of high temperature or steam generated from dehydrating gypsum particle causes a hydration reaction on the surface of clinker particles, a phenomenon known as prehydration.
2. In large scale grinding mills at elevated temperatures during milling process of clinker with gypsum in plant, gypsum starts losing its water of crystallization and transforms into different forms of calcium sulfate with less than 2 molecules of water of crystallization, such as CaSO₄.nH₂O where 2>n>0.5; or CaSO₄.½H₂O (hemihydrate); or CaSO₄.nH₂O where 0.5>n>0; or even CaSO₄ (soluble anhydrite). Due to hydration reaction on the surface of clinker particle (as mentioned above), some sort of gap or barrier is created between clinker particle and dehydrated gypsum particle which result in loose packing and lesser affinity between clinker particle and changed form of gypsum particle. Thus, more the gypsum dehydrates and lose its water of crystallization, more will be the generation of high temperature water vapors or steam, causing more hydration reaction on the surface of clinker particle, which would result in larger gaps or barrier between clinker particle and dehydrated form of gypsum particle. This results in lesser affinity between clinker particle and changed form of gypsum particle towards each other and loose packing between them.
3. At high temperature in grinding mill the continuously dehydrating gypsum undergoes chemical and physical changes and in presence of hydration reaction on the surface of clinker particle these changes on dehydrating gypsum particle results in further lesser affinity and lose packing between dehydrating/changed form of gypsum particle and clinker particle.
4. Cement strength depends on many factors and one major factor among them is compaction. The more compacted the cement paste is, higher will be the ultimate strength of cement products manufactured from it like mortar, concrete and the like. Water required or used to make cement paste or its products is inversely proportional to compaction of cement paste or its products. The water required by cement to make a workable paste is known as normal consistency (N/C) of cement. Lower the N/C of cement, higher is the ultimate strength of the cement. This N/C of cement largely depends on the immediate availability of sulfate ions in pore solution, their rapid attack on C₃A and immediate reaction between calcium sulfate and C₃A of clinker when water is mixed with cement and a paste is formed. The sulfate ions are provided in pore solution either from dissolution of gypsum or its dehydrated forms with less than 2 molecules of water of crystallization [i.e., CaSO₄.nH₂O where 2>n>0.5 or hemihydrate(CaSO₄.½H₂O) or CaSO₄.nH₂O where 0.5>n>0 or soluble anhydrite(CaSO₄)], depending on what form of calcium sulfate is present in cement. The rapid attack of sulfate ions on C₃A in pore solution and water requirement or N/C of cement paste depends upon following factors:
   a. How closely gypsum particles or its dehydrated form [i.e., CaSO₄.nH₂O where 2>n>0.5 or hemihydrate(CaSO₄.½H₂O) or CaSO₄.nH₂O where 0.5>n>0 or soluble anhydrite(CaSO₄)] are packed with clinker particles in cement.
   b. Solubility and dissolution rate of any particular form of calcium sulfate to provide sulfate ions rapidly in pore solution.
   c. Tendency of gypsum or its dehydrated form [i.e., CaSO4.nH2O where 2>n>0.5 or hemihydrate(CaSO4.½H2O) or CaSO4.nH2O where 0.5>n>0 or soluble anhydrite(CaSO4)] to react immediately with C3A in pore solution.
   d. The optimum concentration of sulfate ions in pore solution. The hydration reaction on the surface of clinker particle during inter grinding, the gap/barrier between dehydrated form of gypsum particle and clinker particle and loose packing between them inhibits and delays the attack of sulfate ions on C₃A and reaction between changed form of gypsum and C₃A, which should be immediate otherwise. Due to this barrier and delay, the water demand or N/C of cement increases, which results in a product of lesser strength.
5. The release and availability of sulfate ions in pore solution of cement paste from gypsum (natural or chemical) or it's changed forms [i.e., CaSO₄.nH₂O where 2>n>0.5 or hemihydrate(CaSO₄.½H₂O) or CaSO₄.nH₂O where 0.5>n>0 or soluble anhydrite(CaSO₄)] generated during inter grinding process or from natural anhydrite, depends on the dissolution rate of that particular form of calcium sulfate in water at 27° C. The dissolution rate of different forms of calcium sulfate are in decreasing order as follows:
   a. Hemihydrate(CaSO₄.½H₂O)˜Soluble Anhydrite (CaSO₄)>Gypsum (CaSO₄.2H₂O)>Insoluble Anhydrite (CaSO₄); and
   b. Insoluble or natural anhydrite has very poor dissolution rate and it does not react with C₃A of cement at early stages of cement hydration.

Higher the dissolution rate of a particular form of calcium sulfate present in cement, better is the scenario to rapidly supply sulfate ions in pore solution, which is likely to enhance the phenomenon of immediately controlling the C₃A hydration and minimizing the formation of calcium aluminate hydrate at the very initial moments when water is mixed with cement resulting in lower water requirement of cement paste or N/C of cement, which will produce a cement higher in strength and durability. During inter grinding of clinker with gypsum at elevated temperature gypsum starts dehydrating into more soluble forms like CaSO₄.nH₂O (where 2>n>0.5) or hemihydrate or CaSO₄.nH₂O (where 0.5>n>0) or soluble anhydrite but because of the reasons already mentioned (like hydration reaction on the surface of clinker particle, loose packing between clinker particle and dehydrated form of gypsum particle and the gap/barrier between dehydrated form of gypsum particle and clinker particle), the attack of sulfate ion on C₃A and reaction between changed form of gypsum and C₃A gets delayed even though the dehydrated form of gypsum having higher dissolution rate is present in cement.
6. It has been observed that in large scale grinding mills at cement manufacturing plant during inter grinding process of clinker and gypsum along with other raw materials, which are added optionally based on type of cement and other requirements, if the gypsum is allowed to dehydrate largely into forms like hemihydrate(CaSO₄.½H₂O) or CaSO₄.nH₂O (where 0.5>n>0) or soluble anhydride(CaSO₄), which can be done by simply letting the temperature of grinding mill to rise, then
   a. Water demand or N/C of cement paste increases along with the higher chances of FALSE SET.
   b. Cement shows poor rheology.
   c. The strength of cement and products made from it reduces at all stages.
   d. The cement is likely to have many more problems including compatibility with 25 different water reducing admixtures.
      In cement, with optimum percentage of SO₃, usually there exists equilibrium, particularly at the very initial moments when water is mixed with cement, in dissolution rate of any particular form of calcium sulfate in pore solution and reaction of dissolved calcium sulfate (of any particular form) with C₃A of cement. When too much of gypsum is allowed to dehydrate, during inter grinding process, into hemihydrate or soluble anhydrite this equilibrium gets disturbed because of hydration reaction on the surface of clinker particle, lesser affinity between clinker particle and dehydrated form of gypsum particle and a gap or barrier between these particles. And because of these reasons the dehydrated forms of gypsum generated during inter grinding has more tendency to precipitate gypsum (calcium sulfate dihydrate CaSO₄.2H₂O) out of pore solution rather than reacting with C₃A of clinker/cement, resulting in false set of cement paste and higher N/C. This tendency is highest when gypsum is allowed to convert totally into Soluble anhydrite followed by CaSO₄.nH₂O where 0.5>n>0, followed by hemihydrate and so on, produced by dehydration of gypsum during inter grinding of clinker with gypsum. More the percentage of changed forms of gypsum (especially soluble anhydrite or CaSO₄.nH₂O where 0.5>n>0 or hemihydrate) generated during inter grinding process of cement, more is the likelihood of occurrence of these problems.
7. During inter grinding of clinker with gypsum along with other raw materials in large scale mills at cement manufacturing plants, due to the rise in temperature of mill and raw materials, some part of gypsum is expected to convert into hemihydrate (CaSO₄.½H₂O) and nearly all of the gypsum to be dehydrated to some degree generating CaSO₄.nH₂O where 2>n>0.5. This significantly affect the physical and chemical properties of cement, but because of high throughput and highly dynamic conditions of plant/mill, it is a great challenge to maintain an ideal conversion ratio of gypsum into hemihydrate or to control the percentage of gypsum dehydration. There are many parameters to control when clinker is ground with gypsum while producing cement in plant, and a small change may lead to undesired ratio of hemihydrate or too much dehydrated gypsum in cement.
   Presently due to the problems associated with transformation of gypsum during inter grinding process of clinker with gypsum along with other raw materials like Fly ash, Slag etc. (which are optionally added) in plant, cement manufacturers generally maintain the mill temperature in a zone where not too much dehydration of gypsum takes place. It is possible that cement produced in Laboratory in a small ball mill, that means inter-grinding clinker with gypsum and other ingredients, will have less N/C and higher strength than cement produced in plant on large scale with same recipe. In laboratory ball mills temperatures can be maintained at about 35° C., which means no dehydration of gypsum, and gypsum particles and clinker particles are packed/attached together in optimum manner, which leads to quick reaction between C₃A compound and gypsum in pore solution, resulting in less water demand or N/C of cement, hence higher strength. This envisages that by maintaining the temperature of plant mill below 40° C., the transformation of gypsum will not take place which will avoid the problems associated with dehydration of gypsum during grinding process of cement and ultimately better quality cement is obtained. This, however, poses some challenges—
a. It is challenging to maintain the temperature of large scale plant mills below 40° C. by current measures and right practice, because of high throughput and dynamic conditions of plant. Moreover, even if somehow the grinding operations are maintained at 40° C., there is need to keep entire line afterwards from storage in silos to packing under 50° C., otherwise the gypsum will start dehydrating and generate water vapors though in small percentage but enough to cause permanent damage in silos or any other part of plant. Pre-hydration will occur and lumps created in final product are highly undesirable.
b. It is possible to accelerate hydration of C₃S(alite), C₂S (belite), Fly Ash, slag or any other pozzolan and activate Fly ash, Slag or any other pozzolan in any particular cement with hemihydrate (CaSO₄.½H₂O), CaSO₄.nH₂O where 0.5>n>0 and soluble anhydrite(CaSO₄) present in that particular cement. In recent times, however, getting strength quickly in any kind of cement is a major factor. Earlier higher the strength of cement or its products like mortar or concrete was attained, the lesser is the necessity to cure that product. Curing for long time now a days is a bigger challenge. Apart from laboratory conditions, practically none of the cement products like mortar or concrete are properly cured for full time length of 28 days, due to huge labor involvement and a cumbersome process to manage and cost involved. In India PPC cement is manufactured around 65% of total production of cement and one day strength matters a lot in the market. Cement with high (permissible) limits of fly ash is not available, and the early age strength especially one day strength, falls steeply as soon as fly ash is increased in current methods of manufacturing PPC cement.

### OBJECTS OF THE INVENTION

The main object of the present invention is to provide an improved method for manufacturing cement which is devoid of any drawbacks and problems identified above in the cement manufacturing methods known in the prior art.

Accordingly, one of the prime objects of the present invention is to provide a method of manufacturing cement which reduces CO₂ emission during manufacturing.

Another object of the present invention is to provide a method of manufacturing cement which increases the overall strength of the cement at all ages.

Yet another object of the present invention is to provide a method of manufacturing cement which reduces water demand (Normal Consistency) of cement.

Still another object of the present invention is to provide a method of manufacturing cement which accelerates the hydration rate of C₂S, C₃S, fly ash, slag or any other pozzolan in the cement.

Yet another object of the present invention is to provide a method of manufacturing cement which enables better activation of fly ash, slag or any other pozzolan in the cement.

Still another object of the present invention is to provide a method of manufacturing cement which enables increased percentage of Fly Ash in cement while also increasing the strength of the cement, and without compromising early stage strength of the cement.

A preferred object of the present invention is to provide a method of manufacturing cement which enables increased percentage of Slag in the cement.

Still another object of the present invention is to provide a method of manufacturing cement which enables reduced amount of C₃S and increase the C₂S levels in the cement, without compromising early strength of the cement.

Another preferred object of the present invention is to provide a method of manufacturing cement which improves the rheology of cement.

Yet another object of the present invention is to provide a method of manufacturing cement which reduces fuel consumption, increases kiln output, and also increases durability of the cement.

The other objects, preferred embodiments and advantages of the present invention will become more apparent from the following detailed description of the present invention when read in conjunction with the accompanying examples, figures and tables, which are not intended to limit scope of the present invention in any manner.

### STATEMENT OF THE INVENTION

Accordingly, the present invention provides a method of manufacturing cement, the said method comprising: (a) determining or fixing the highest temperature T° C. that the working mix is expected to reach inside the mill during inter-grinding gypsum (or a dehydrated form thereof) with clinker; (b) calcining the gypsum at a temperature W° C., such that W>=0.9 T; and (c) inter-grinding the pre-calcined gypsum with the clinker inside mill such that the highest temperature of working mix inside the mill does not exceed T° C., wherein that the change in water of crystallization of gypsum (or a dehydrated form thereof) during inter-grinding with clinker in step (c) is minimal.

### DESCRIPTION OF THE DRAWINGS

The foregoing and other objects of the invention will be apparent upon consideration of the following detailed description, taken in conjunction with the accompanying drawings, in which:

FIG. 1 is a graphical illustration comparing the compressive strengths of Cement I (OPC 53 G with Gypsum); Cement II (OPC 53 G with Hemihydrate); and Cement III (OPC 53 G with Soluble Anhydrite);

FIG. 2 is a graphical illustration comparing the normal consistencies of Cement I (OPC 53 G with Gypsum); Cement II (OPC 53 G with Hemihydrate); and Cement III (OPC 53 G with Soluble Anhydrite);

FIG. 3 is a graphical illustration comparing the initial and final setting time of Cement I (OPC 53 G with Gypsum); Cement II (OPC 53 G with Hemihydrate); and Cement III (OPC 53 G with Soluble Anhydrite);

FIG. 4 is a graphical illustration comparing the compressive strengths between Cement IV (PPC with Gypsum and 25% Fly Ash); and Cement V (PPC with Hemihydrate and 25% Fly Ash);

FIG. 5 is a graphical illustration comparing the compressive strengths between Cement VI (PPC with Gypsum and 35% Fly Ash); and Cement VII (PPC with Hemihydrate and 35% Fly Ash);

FIG. 6 is a graphical illustration comparing the normal consistencies of Cement IV (PPC with Gypsum and 25% Fly Ash); and Cement V (PPC with Hemihydrate and 25% Fly Ash); Cement VI (PPC with Gypsum and 35% Fly Ash); and Cement VII (PPC with Hemihydrate and 35% Fly Ash);

FIG. 7 is a graphical illustration comparing the initial and final setting time among Cement IV (PPC with Gypsum and 25% Fly Ash); and Cement V (PPC with Hemihydrate and 25% Fly Ash); Cement VI (PPC with Gypsum and 35% Fly Ash); and Cement VII (PPC with Hemihydrate and 35% Fly Ash); and

FIG. 8 shows a graphical representation on the amount of CO₂ emitted during the conventional method, and the present method of production of cement.

### DETAILED DESCRIPTION OF THE INVENTION

It must be understood that the specific processes illustrated in the drawings and described in the following specifications are simply exemplary embodiments of the inventive concept defined and claimed in the appended claims. Hence, the specific figures, physical properties, parameters, and characteristics relating to the embodiments disclosed herein are not to be considered as limiting, unless claims expressly state otherwise. Also, it will be understood by one having ordinary skill in the art that construction of the described disclosure is not limited to a specific method. Other exemplary embodiments of the disclosure herein may be formed from a wide range of possible variations, unless described otherwise herein. Unless the context clearly dictates otherwise, the singular forms (including “a”, “an”, and “the”) in the specification and appended claims shall mean and include the plural reference as well.

Unless the context clearly dictates otherwise, it is understood that when a range of value is provided, the tenth of the unit of the lower limit as well as other stated or intervening values in that range shall be deemed to be encompassed within the disclosure. Where the stated range includes one or both of the limits, ranges excluding either or both of those included limits are also included in the disclosure.

It is to be noted that the construction and arrangement of parameters for method as described in the exemplary embodiments is illustrative only. Although only a few embodiments of the present invention have been described in the detail in this disclosure, those skilled in the art will readily appreciate that many modifications and variations are possible (such as variation of temperatures, dimension of particles, type of raw material, proportions of various elements, values of parameters, use of additional materials, etc.) without materially departing from the novel and innovative teachings and essence of the invention with the advantages of the subject matter recited. The method of manufacturing cement as described and claimed in the present specification may not include all the details of all the standardized procedures and functions with respect to cement manufacturing which are known in the industry. For example, the present invention may not describe the methods or machines/tools employed for inter-grinding of the clinker or gypsum or their inter-grinding, and how to maintain/regulate the mill temperature, and the source of raw material to be used. Conventionally, many practical alternatives are available in the industry with respect to these features and parameters, and it is also possible that the variation in these external parameters/procedures may also result in the variation in output of the method and the quality of cement manufactured. It is, however, submitted that the mere variations or modifications of these external parameters does not take away, circumvent or deviate from the scope of the present invention as long as the features of the present invention are also employed in the method for manufacturing cement. Accordingly, all such modifications are intended to be included within the scope of the present invention. Other substitutions, modifications, changes and omissions may be made in the design, operating conditions, and arrangement of the desired and other exemplary embodiments without departing from the spirit of the present invention.

The exemplary and/or preferred embodiments of the method disclosed below are for illustrative purposes only and are not to be construed as limiting.

Accordingly, the present invention provides an improved method of manufacturing cement which is devoid of the drawbacks/problems in the existing methods of manufacturing cement, as identified above. According to a preferred embodiment of the present invention, the method of manufacturing cement comprise the following steps:
a. Gypsum is first ground in a separate mill to a desired fineness.
b. Gypsum is calcined (at a pre-determined temperature range) to synthesize dehydrated form(s) thereof—CaSO₄.nH₂O (where 2>n>0.5); CaSO₄.½H₂O (Hemihydrate); CaSO₄.nH₂O (where 0.5>n>0); and/or CaSO₄ (Soluble Anhydrite).
   c. The ground and calcined gypsum [or dehydrated form(s) thereof] is then intergrinded with clinker such that the highest temperature while inter-grinding does not exceed a pre-determined maximum temperature range.

Other raw materials like fly ash, slag etc. are added optionally based on type of cement and other requirements, at final inter-grinding stage to produce cement. This method activates fly ash or slag (if present in any particular cement) and accelerates hydration rate of C₃S, C₂S, fly ash or slag in the cement while reducing water demand and improving rheology of the cement, thereby enhancing the strength and durability of cement with less carbon emissions during manufacturing.

Thus, according to the present invention and improved process of manufacturing cement, at final grinding stage, gypsum is replaced by specially synthesized calcined gypsum [CaSO.nH₂O (where 2>n>0.5) or CaSO₄.½H₂O (Hemihydrate) or CaSO₄.nH₂O (where 0.5>n>0) or CaSO₄ (Soluble Anhydrite)] which is inter-ground with clinker and other raw materials, which are added optionally based on type of cement and other requirements, to produce any particular kind of cement. This is in contrast to the conventional method of producing cement wherein the clinker is directly inter-grinded with gypsum. In the conventional methods, as the temperature of mill rise, gypsum loses its water of crystallization and transform into dehydrated forms [CaSO₄.nH₂O (where 2>n>0.5) or CaSO₄.½H₂O (Hemihydrate) or CaSO₄.nH₂O (where 0.5>n>0) or CaSO₄ (Soluble Anhydrite)] in the mill. As explained earlier, too much dehydration of gypsum in cement production is highly undesirable and causes problems in cement and degrades its quality.

According to the present invention, it has been observed and surprisingly found by the inventor that by replacing gypsum with pre-calcined (dehydrated form) of gypsum during inter-grinding stage with clinker minimizes the change in water of crystallization of gypsum during inter-grinding, and thus minimizes the release of water vapors of high temperature or steam. The problem arise in cement if we use gypsum at inter-grinding stage with clinker and let the gypsum to dehydrate and convert into hemihydrate or other dehydrated forms of gypsum while generating water vapors of high temperature or steam. Thus, replacing gypsum with a pre-calcined gypsum and then inter-grind it with raw clinker along with other raw materials (which are optionally added to produce any particular kind of cement) gives results which are surprising and in complete contradiction with current understanding and belief. It has been observed that, for a cement with optimum % of SO₃ content, high dissolution rate of hemihydrate or other dehydrated forms of gypsum is not a problem especially when they are present as the complete source of calcium sulfate, added 10 externally replacing gypsum, in any cement.

If no hydration occurs on surface of clinker particle during inter-grinding, there is no barrier between clinker particle and calcium sulfate particles [CaSO₄.nH₂O (where 2>n>0.5) or CaSO₄.½H₂O (Hemihydrate) or CaSO₄.nH₂O (where 0.5>n>0) or CaSO₄ (Soluble Anhydrite)] and both particles are tightly packed. When the particles of dehydrated form of gypsum attach to the best possible site on clinker particle, the dissolution rate of the dehydrated form of gypsum particles and the rate of reaction between C₃A and CaSO₄.nH₂O (where 2>n>0.5) or CaSO₄.½H₂O (Hemihydrate) or CaSO₄.nH₂O (where 0.5>n>0) or CaSO₄ (Soluble Anhydrite) was found to be in equilibrium, thereby reducing the probability of precipitating gypsum out of pore solution. The optimum SO₃% for cements was found to be around 2%˜2.2% including SO₃ inbound in clinker and other raw materials.

According to the literature, articles, journals and books in the prior art on cement manufacturing technology, its mentioned everywhere and always been feared that if hemihydrate is present in excess quantity (say more than 30% of gypsum or total calcium sulfate source added externally), then strength, quality and compatibility of cement will be poor and have issues. And if somehow good amount of soluble anhydrite gets generated during cement production then that cement will be practically of no use. Surprisingly, as per present invention, it is found that 100% hemihydrate or soluble anhydrite as the source of calcium sulfate added externally while replacing gypsum in any cement is not only not a problem, but it is advantageous in terms of strength, cost effectiveness and durability. The prior art, therefore, teaches away from the present invention. As per present invention when CaSO₄.nH₂O (where 2>n>0.5) or CaSO₄.½H₂O (Hemihydrate) or CaSO₄.nH₂O (where 0.5>n>0) or CaSO₄ (Soluble Anhydrite) is inter-grinded with clinker (irrespective of the clinker temperature), the particle of dehydrated form of gypsum will be tightly packed with clinker particle during inter-grinding. The surface charge on clinker particle and on dehydrated form of gypsum particle plays favorable role to attach the latter on the best possible site on clinker particle where it reacts immediately with C₃A of clinker rather than precipitating gypsum out of solution when water is mixed with cement.

As per present invention one important thing has been observed that blending of separately ground gypsum or dehydrated form thereof and separately ground clinker is unfavorable. In this case surface chemistry plays important role, when clinker is separately ground, its particle gets agglomerated and hence when one try to blend separately ground gypsum or dehydrated form thereof with separately ground clinker then the clinker particles and gypsum particles gets loosely packed as a result when water is mixed with cement, rather than completely reacting with C₃A, it precipitates gypsum out of pore solution in huge quantity, which gives a serious problem of false set, poor strength, and compatibility issues with water reducing admixtures, poor rheology etc.

In another preferred embodiment of the present invention, first the highest temperature T° C. that the working mix is expected to reach inside the mill during intergrinding gypsum (or a dehydrated form thereof) with clinker the gypsum is determined, and then the gypsum is pre-calcined at a temperature which is at least equal to or higher than the said identified maximum temperature.

According to one of the most preferred embodiments of the present invention, the gypsum is pre-calcined at a temperature which is at least more than 90% the maximum temperature which is expected to reach inside the mill during inter-grinding of gypsum (or a dehydrated form thereof) with clinker.

In accordance with another preferred embodiment of the present invention, gypsum is pre-calcined at a temperature such that more than 50% of gypsum is dehydrated to hemihydrate form [CaSO₄.½H₂O]. In accordance with another preferred embodiment of the present invention, gypsum is pre-calcined at a temperature such that more than 80% of gypsum is dehydrated to hemihydrate form [CaSO₄.½H₂O].

In accordance with another preferred embodiment of the present invention, gypsum is pre-calcined at a temperature such that more than 50% of gypsum is dehydrated to a form of calcium sulphate with water of crystallization less than 0.5 [CaSO₄.nH₂O, where 0.5>n>=0]. In accordance with another preferred embodiment of the present invention, gypsum is pre-calcined at a temperature such that more than 80% of gypsum is dehydrated to a form of calcium sulphate with water of crystallization less than 0.5 [CaSO₄.nH₂O, where 0.5>n>=0]. In accordance with another preferred embodiment of the present invention, gypsum is pre-calcined at a temperature such that more than 50% of gypsum is dehydrated to soluble anhydrite form [CaSO₄.nH₂O, where 0.05>n>=0]. In accordance with another preferred embodiment of the present invention, gypsum is pre-calcined at a temperature such that more than 80% of gypsum is dehydrated to soluble anhydrite form [CaSO₄.nH₂O, where 0.05>n>=0]. In accordance with another preferred embodiment of the present invention, gypsum is first ground or pulverized to a size of less than about 75 20 microns, and preferably to a size less than about 45 microns before being calcined.

In accordance with another preferred embodiment of the present invention, wherein the inter-grinding of pre-calcined gypsum with clinker is carried out in presence of raw materials selected from the group consisting of fly ash, slag, volcanic ash, rice husk ash, meta kaolin, silica fume, and limestone. The method of manufacturing cement in accordance with the present invention also enables higher use of fly ash (in the range of up to 35%) without compromising the early strength (or day one strength) of the cement.

The cement manufactured in accordance with the present invention has the following characteristics:
1. During the inter-grinding process of Clinker with specially synthesized CaSO₄.nH₂O where 1>n>0.5 or hemihydrate (CaSO₄.½H₂O) or CaSO₄.nH2O where 0.5>n>0 or soluble anhydrite (CaSO4) along with other raw materials like fly ash, slag etc., which are added optionally based on type of cement and other requirements, at elevated temperatures of grinding mill around 90° C.˜150° C. no water vapors of high temperature or steam generates from CaSO4.nH2O where 1>n>0.5 or hemihydrate (CaSO₄.½H₂O) or CaSO₄.nH₂O where 0.5>n>0 or soluble anhydrite(CaSO4) hence no hydration reaction takes place on the surface of clinker particle.
2. The CaSO4.nH2O where 1>n>0.5 particle or hemihydrate(CaSO4.½H2O) particle or CaSO4.nH2O where 0.5>n>0 particle or soluble anhydrite(CaSO4) particle and clinker particle have very high affinity towards each other and both are packed in perfect manner to each other in any particular kind of manufactured cement like, OPC, PPC, PSC etc.
3. After addition of water to cement the specially synthesized CaSO4.nH2O where 1>n>0.5 or hemihydrate(CaSO₄.½H₂O) or CaSO4.nH2O where 0.5>n>0 or soluble anhydrite (CaSO4) dissolves and rapidly release sulfate ions in pore solution and reacts immediately with C3A at the very initial moments after water is mixed with cement, 20 minimizing the formation of calcium aluminate hydrate.
4. The equilibrium of dissolving CaSO4.nH2O where 1>n>0.5 or hemihydrate (CaSO₄.½H₂O) or CaSO4.nH2O where 0.5>n>0 or soluble anhydrite(CaSO₄) into pore solution and their immediate reaction with C3A is in perfect manner.
5. The rapid reaction between CaSO4.nH2O where 1>n>0.5 or hemihydrate (CaSO₄.½H₂O) or CaSO4.nH2O where 0.5>n>0 or soluble anhydrite (CaSO₄) and C₃A, immediately controls and slow down C₃A hydration and hence cement hydration for some time.
6. There is nil tendency of dissolved CaSO4.nH2O where 1>n>0.5 or hemihydrate (CaSO₄.½H₂O) or CaSO4.nH2O where 0.5>n>0 or soluble anhydrite (CaSO₄) to precipitate gypsum out of pore solution rather than immediately reacting with C3A.
7. There are, therefore, nil chances of false set in cement because of external and controlled addition of SO3 in form of CaSO4.nH2O where 1>n>0.5 or hemihydrate (CaSO₄.½H₂O) or CaSO4.nH2O where 0.5>n>0 or soluble anhydrite (CaSO₄).
8. The water requirement or N/C of cement produced with the method of present invention is less than the conventional method giving more compact cement paste with low porosity hence enhancing strength of cement at all ages.
9. Depending on type of cement produced by the method of present invention like OPC, PPC, or PSC, the fly ash or slag or other pozzolans are better activated. Also the 15 hydration rate of C3S, C2S, fly ash, slag or other pozzolans of cement is accelerated.
10. The rheology of cement is improved a lot providing huge benefits in production of mortar, concrete etc. made from the cement produced by the method of present invention.
11. All these positive changes result in better strength and durability of cement and products produced from the cement like mortar, concrete etc. at all ages.

### EXAMPLES

The inventor of the present invention carried out large number of experiments to establish and confirm the finding of the present invention. The results of some of these experiments is provided herein below by way of examples. It is to be noted that these examples are by way of illustration only, and does not limit the scope of the present invention in any manner.

Clinker—The clinker used in producing cement in accordance with the preferred embodiments of the present invention is one of the commercially available clinkers in market with following chemical composition:
SiO₂ 21.55% Al₂O₃ 5.54%
Fe₂O₃ 4.45%
CaO 64.48%
MgO 1.07%
SO₃ 1.13%
K₂O 0.51%
Na₂O 0.20%
LOI 0.31%
IR 0.25%
Free Lime 1.22%
LSF 0.90
C₃S 50.12
C₂S 24.0
C₃A 7.15
C₄AF 13.54

The clinker used in all cements have moderate level of C₃S and LSF (lime saturation factor). There are, however, companies which are producing clinkers with high percentage content of C₃S (around 55% to 60%) and LSF (of about 0.95 to 0.98) in order to produce high strength cement, but high C₃S clinkers need more energy, High Grade Limestone Mines, and are costlier to produce. Also, the cement produced with high percentage content of C₃S clinkers have high shrinkage, cracking problems and are less durable. If high strength, especially early age strength, can be achieved with clinkers having lower % of C₃S then, then more durable cements can be produced.

Gypsum—For the purposes of better illustration, the below-mentioned two kind of dehydrated forms of gypsum [i.e., hemihydrate (CaSO₄.½H₂O) or CaSO₄.nH₂O where 0.5>n>0 or soluble anhydrite (CaSO₄)] were tested.
1. Beta form—wherein the dehydrated form [i.e., hemihydrate (CaSO₄.½H₂O) or CaSO₄.nH₂O where 0.5>n>0 or soluble anhydrite(CaSO₄)] was prepared by grinding/pulverizing mineral gypsum (gypsum from other sources can also be used like marine gypsum or synthetic gypsum etc.) and calcining it at temperature ranging from about 115° C. to about 170° C.; and
2. Alpha form—wherein dehydrated form [i.e., hemihydrate (CaSO₄.½H₂O) or CaSO₄.nH₂O where 0.5>n>0 or soluble anhydrite (CaSO₄)] was prepared from selenite gypsum by the process of autoclaving and calcining already known. Alpha product is very high in cost, so its use in cement industry is usually avoided. Moreover, large machinery is required to produce alpha form of gypsum as well. It is also observed that if alpha form is used then it reduces the grinding efficiency of clinker/cement in ball mill, whereas beta form increases the grinding efficiency of clinker/cement with respect to gypsum.

For the purposes of illustrating the present invention by way of examples, three sets of cements were produced namely first set OPC, second and third set PPC with 25% fly ash and 35% fly ash, which makes a total of 7 kinds of cements wherein 3 types of cements with conventional method using gypsum at inter-grinding stage along with clinker and fly ash; and 4 types of cements, in which gypsum was replaced with hemihydrate and soluble anhydrite, by inter-grinding clinker and fly ash with specially synthesized hemihydrate and soluble anhydrite from gypsum. Gypsum was first ground around 45 microns and then:
a. was calcined at about 115° C. to remove its ¾th water of crystallization to produce hemihydrate with water of crystallization around ½H₂O; or
b. was calcined at about 170° C. to remove its both molecules of water of crystallization to produce soluble anhydrite (CaSO₄).

The gypsum used in reference mix and to synthesize hemihydrate and soluble anhydrite was mineral gypsum of 90% purity.

First Set: Three cements of OPC 53 Grade were produced by inter-grinding clinker with:
a. Gypsum using conventional method of manufacturing (Cement 1, Reference Mix);
b. Synthesized hemihydrate (Cement 2); and
c. Soluble anhydrite (Cement 3) in Ball Mill.

No grinding aid was used. The temperature of mill discharge product was maintained around 110°˜130° centigrade.

### Example I:

Cement I (Reference Mix, conventional method using gypsum): This reference mix produced by the conventional method comprises of 95.8% of clinker; and 2.2% of gypsum; and 2% of fly-ash. Cement 1 is tested for its properties and the observed physical and chemical properties are tabulated in Table 1.

TABLE 1

| S. No | Properties | Units | |
|---|---|---|---|
| 1. | Compressive Strength: | | |
| | 1 Day | 24.4 | MPa |
| | 3 Days | 40.2 | MPa |
| | 7 Days | 51.7 | MPa |
| | 28 Days | 73.4 | MPa |
| 2. | Fineness | 297 | (m²/kg) |
| 3. | Normal Consistency | 28.50% | |
| 4. | Sulphuric Anhydrite | 2.0% by mass | |
| 5. | Setting Time: | | |
| | Initial | 150 | Minutes |
| | Final | 220 | minutes |
| 6. | Soundness: | | |
| | Le Chatelier | 1.0 | mm |

| | |
|---|---|
| Autoclave | 0.06% |

### Example II:

Cement II (with hemihydrate as per present invention): This mix produced by new method comprises of 96.1% of clinker; 1.9% of hemihydrate; and 2% of fly-ash. Cement II is tested for its properties and the observed physical and chemical properties are tabulated in Table 2.

TABLE 2

| S. No | Properties | Units | |
|---|---|---|---|
| 1. | Compressive Strength: | | |
| | 1 Day | 30.5 | MPa |
| | 3 Days | 49.6 | MPa |
| | 7 Days | 63.2 | MPa |
| | 28 Days | 88.1 | MPa |
| 2. | Fineness | 294 | (m²/kg) |
| 3. | Normal Consistency | 24.25% | |
| 4. | Sulphuric Anhydrite | 2.03% by mass | |
| 5. | Setting Time: | | |
| | Initial | 130 | Minutes |
| | Final | 180 | minutes |
| 6. | Soundness: | | |
| | Le Chatelier | 1.0 | mm |

| | |
|---|---|
| Autoclave | 0.06% |

### Example III:

Cement III (with soluble anhydrite as per present invention): This mix produced by new method comprises of 96.2% of clinker; 1.8% of soluble anhydrite; and 2% of flyash. Cement III is tested for its properties and the observed physical and chemical properties are tabulated in Table 3.

TABLE 3

| S. No | Properties | Units | |
|---|---|---|---|
| 1. | Compressive Strength: | | |
| | 1 Day | 32.6 | MPa |
| | 3 Days | 51.5 | MPa |
| | 7 Days | 65.9 | MPa |
| | 28 Days | 93.3 | MPa |
| 2. | Fineness | 293 | (m²/kg) |
| 3. | Normal Consistency | 23.00% | |
| 4. | Sulphuric Anhydrite | 2.04% by mass | |
| 5. | Setting Time: | | |
| | Initial | 140 | Minutes |
| | Final | 190 | minutes |
| 6. | Soundness: | | |
| | Le Chatelier | 1.0 | mm |

| | |
|---|---|
| Autoclave | 0.06% |

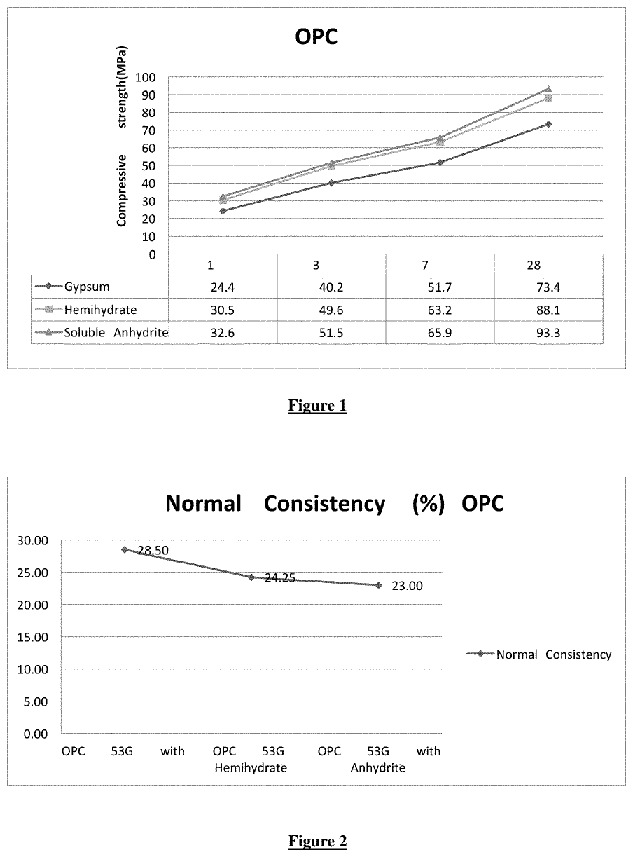

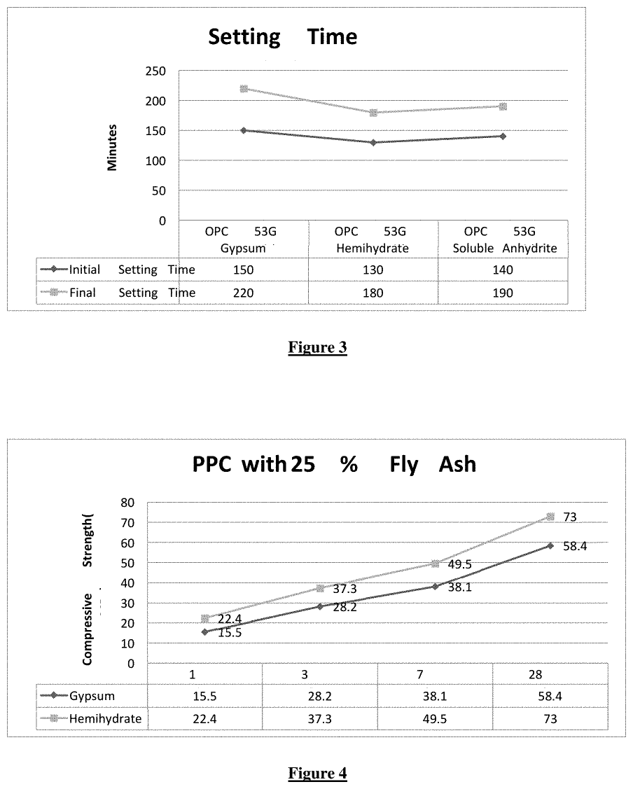

FIG. 1 shows a graphical illustration comparing the compressive strengths of the above three varieties of cements (viz. Cement I, Cement II and Cement III). It is observed that Cement III has the highest compressive strength than the other two varieties. It is also observed that Cement II and Cement III have similar normal consistency (24.25% and 23%) in comparison to Cement I as illustrated in FIG. 2. Further, the initial and final time taken for setting is lesser in Cement II and Cement II in comparison to Cement I as illustrated in the graphical representation of FIG. 3.

Second Set: Two cements of PPC grade were produced by inter-grinding clinker 10 with
a. Gypsum and 25% fly ash; and
b. Specially synthesized hemihydrate and 25% fly ash in ball mill.

No grinding aid was used. The temperature of mill discharge product was maintained around 100° C.˜110° C.

### Example IV:

Cement IV (Reference Mix, conventional method with Gypsum): This reference mix comprises of 72% of clinker; 3% of gypsum; and 25% of fly ash. Cement IV is tested for its properties and the observed physical and chemical properties are tabulated in Table 4.

TABLE 4

| S. No | Properties | Units | |
|---|---|---|---|
| 1. | Compressive Strength: | | |
| | 1 Day | 15.5 | MPa |
| | 3 Days | 28.2 | MPa |
| | 7 Days | 38.1 | MPa |
| | 28 Days | 58.4 | MPa |
| 2. | Fineness | 382 | (m²/kg) |
| 3. | Normal Consistency | 31.75% | |
| 4. | Sulphuric Anhydrite | 2.07% by mass | |
| 5. | Setting Time: | | |
| | Initial | 160 | Minutes |
| | Final | 220 | minutes |
| 6. | Soundness: | | |
| | Le Chatelier | 0.6 | mm |

| | |
|---|---|
| Autoclave | 0.03% |

### Example V:

Cement V (with Hemihydrate as per the present invention): The mix produced by new method comprises of 72% of Clinker; 2.7% of Hemihydrate; and 25.3% of Fly Ash. Cement V is tested for its properties and the observed physical and chemical properties are tabulated in Table 5.

TABLE 5

| S. No | Properties | Units | |
|---|---|---|---|
| 1. | Compressive Strength: | | |
| | 1 Day | 22.4 | MPa |
| | 3 Days | 37.3 | MPa |
| | 7 Days | 49.5 | MPa |
| | 28 Days | 73 | MPa |
| 2. | Fineness | 384 | (m²/kg) |
| 3. | Normal Consistency | 26.50% | |
| 4. | Sulphuric Anhydrite | 2.15% by mass | |
| 5. | Setting Time: | | |
| | Initial | 145 | Minutes |
| | Final | 190 | minutes |
| 6. | Soundness: | | |
| | Le Chatelier | 0.6 | mm |

| | |
|---|---|
| Autoclave | 0.03% |

It is observed that the compressive strength of Cement V (with Hemihydrate and 25%

Fly Ash) is higher than Cement IV (with gypsum and 25% Fly Ash) as shown in 5 FIG. 4.

Third Set: Two cements were produced with 35% fly ash with:
a. Gypsum; and
b. synthesized Hemihydrate.

No grinding aid was used. The temperature of mill discharge product was around 100° C.

### Example VI:

Cement VI (Reference Mix, conventional method with Gypsum): This reference mix produced by conventional method comprises of 62% of Clinker; 3.3% of Gypsum; and 34.7% of Fly Ash. Cement VI is tested for its properties and the observed physical and chemical properties are tabulated in Table 6.

TABLE 6

| S. No | Properties | Units | |
|---|---|---|---|
| 1. | Compressive Strength: | | |
| | 1 Day | 11.8 | MPa |
| | 3 Days | 22.1 | MPa |
| | 7 Days | 31.5 | MPa |
| | 28 Days | 49.3 | MPa |
| 2. | Fineness | 394 | (m²/kg) |
| 3. | Normal Consistency | 33.50% | |
| 4. | Sulphuric Anhydrite | 2.08% by mass | |
| 5. | Setting Time: | | |
| | Initial | 175 | Minutes |
| | Final | 250 | minutes |
| 6. | Soundness: | | |
| | Le Chatelier | 0.5 | mm |

| | |
|---|---|
| Autoclave | 0.025% |

### Example VII:

Cement VII (with Hemihydrate according to the present invention): This reference mix produced by the method disclosed in the present invention comprises of 62% of Clinker; 3% of Hemihydrate; and 35% of Fly Ash. Cement VII is tested for its properties and the observed physical and chemical properties are tabulated in Table 7.

TABLE 7

| S. No | Properties | Units | |
|---|---|---|---|
| 1. | Compressive Strength: | | |
| | 1 Day | 18.8 | MPa |
| | 3 Days | 30.9 | MPa |
| | 7 Days | 44.1 | MPa |
| | 28 Days | 67.2 | MPa |
| 2. | Fineness | 390 | (m²/kg) |
| 3. | Normal Consistency | 27.50% | |
| 4. | Sulphuric Anhydrite | 2.19% by mass | |
| 5. | Setting Time: | | |
| | Initial | 150 | Minutes |
| | Final | 200 | minutes |
| 6. | Soundness: | | |
| | Le Chatelier | 0.5 | mm |

| | |
|---|---|
| Autoclave | 0.025% |

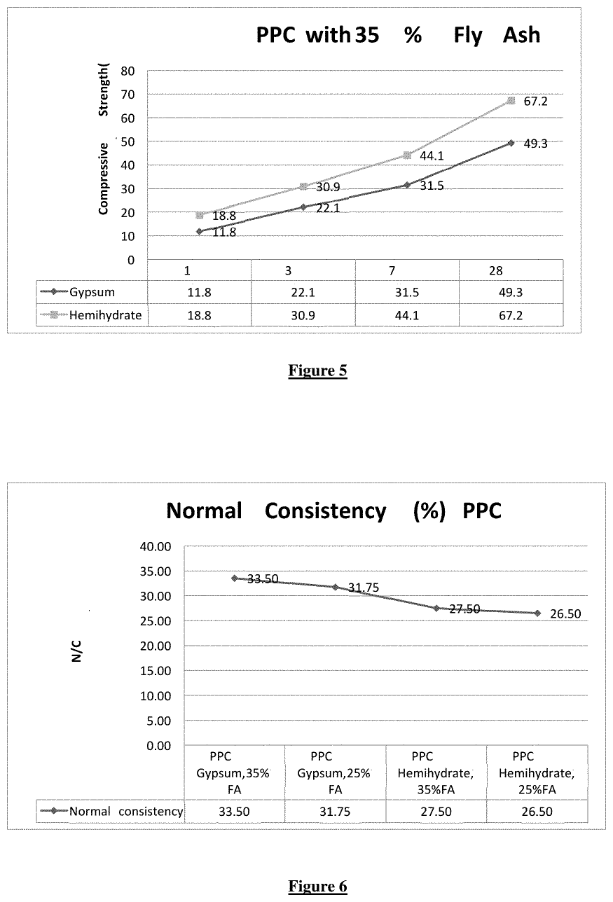

FIG. 5 shows a graphical illustration comparing the compressive strengths of the above two varieties of cement (viz. Cement VI, and Cement VII). It is observed that the compressive strength of Cement VII prepared by the method disclosed in the present invention with the hemihydrate increases with number of days, and has the highest compressive strength.

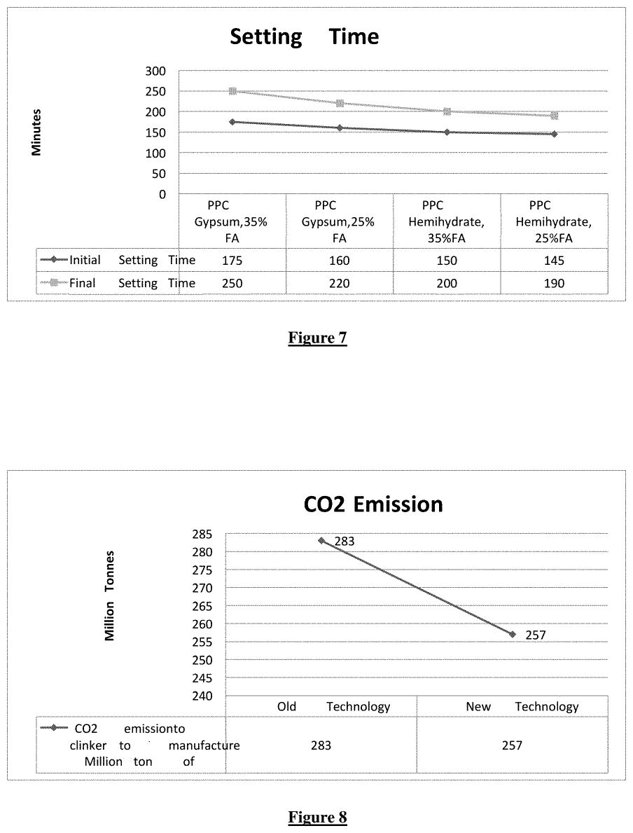

As shown in FIG. 6, Cement V and VII has the preferred normal consistency viz. 26.5% and 27.5% respectively in comparison to Cement IV and Cement VI (viz. 31.75 and 33.5%). Further, the initial and final time taken for setting is also lesser in Cement V (viz. 145 and 190 mins respectively) and Cement VII (viz. 150 and 200 mins respectively) as illustrated in the graphical representation of FIG. 7.

The below table (Table 8) lists the physical and chemical properties of all the seven different types of cements namely Cement I (OPC 53G with gypsum); Cement II (OPC 53G with hemihydrate); Cement III (OPC 53G with soluble anhydrite); Cement IV (PPC with gypsum and 35% FA); Cement V (PPC with hemihydrate and 35% FA); Cement VI (PPC with gypsum and 25% FA); and Cement VII (PPC with hemihydrate and 25% FA) as 20 observed for ease of reference.

TABLE 8

| | | | | | | | | Blaine |
|---|---|---|---|---|---|---|---|---|
| | Cement | % Fly | % | % | % | % Soluble | % | Fineness |
| Sr. No. | Type | Ash | Clinker | Gypsum | Hemihydrate | Anhydride | Limestone | m2/Kg |
| 1 | OPC 53G with Gypsum | 2 | 95.8 | 2.2 | 0.0 | 0.0 | 0.0 | 297 |
| 2 | OPC 53G with Hemihydrate | 2 | 96.1 | 0 | 1.9 | 0.0 | 0.0 | 294 |
| 3 | OPC 53G with Soluble | 2 | 96.2 | 0 | 0.0 | 1.8 | 0.0 | 293 |
| | Anhydrite | | | | | | | |
| 4 | PPC with Gypsum, 35% FA | 34.7 | 62 | 3.3 | 0.0 | 0.0 | 0.0 | 394 |
| 5 | PPC with Gypsum, 25% FA | 25 | 72 | 3 | 0.0 | 0.0 | 0.0 | 382 |
| 6 | PPC with Hemihydrate, | 35 | 52 | 0 | 3 | 0 | 0.0 | 390 |
| | 35% FA | | | | | | | |
| 7 | PPC with Hemihydrate, | 25.3 | 72 | 0 | 2.7 | 0.0 | 0.0 | 384 |
| | 25% FA | | | | | | | |

| | | Initial | Final | Compressive Strength | | | | |
|---|---|---|---|---|---|---|---|---|
| | Normal | setting | setting | (Mpa) | | | | Sulphuric |
| | Consistency | time | time | 1 | 3 | 7 | 28 | Anhydride |
| Sr. No. | % | (minutes) | (minutes) | Day | Day's | Day's | Day's | (%) |
| 1 | 28.50 | 150 | 220 | 24.4 | 40.2 | 51.7 | 73.4 | 2.0 |
| 2 | 24.25 | 130 | 180 | 30.5 | 49.6 | 63.2 | 88.1 | 2.03 |
| 3 | 23.00 | 140 | 190 | 32.6 | 51.5 | 65.9 | 93.3 | 2.04 |
| 4 | 33.50 | 175 | 250 | 11.8 | 22.1 | 31.5 | 49.3 | 2.08 |
| 5 | 31.75 | 160 | 220 | 15.5 | 28.2 | 38.1 | 58.4 | 2.07 |
| 6 | 27.50 | 150 | 200 | 18.8 | 30.9 | 44.1 | 67.2 | 2.19 |
| 7 | 26.50 | 145 | 190 | 22.4 | 37.3 | 49.5 | 73 | 2.15 |

The below table (Table 9) illustrates the data of different types of cement production in India in 2017 including projected increased production of cement and amount of CO₂ emission during manufacturing of such cements.

TABLE 9
Indian cement production data for year 2017

| | | | | | | Increment in |
|---|---|---|---|---|---|---|
| | | | | Current | Projected increased | cement production |
| | | | | Production | production of cement | capacity based on |
| | | Average | Average Fly Ash, | per annum in | with same quantity of | same clinker |
| | | Clinker | Slag or other | Million | clinker production per | production capacity |
| Sr. No. | Cement Type | (%) used | fillers (%) Used | tonnes | annum in million tonnes | (in %) |
| 1 | OPC 43G & 53G old | 95 | 3 | 100 | 0 | |
| | technology | | | | | |
| 2 | OPC 43G & 53G new | 93 | 5 | 0 | 102 | 2 |
| | technology | | | | | |
| 3 | PPC with 27% Fly Ash | 70 | 27 | 270 | 0 | |
| | manufactured with | | | | | |
| | Gypsum, old technology | | | | | |
| 4 | PPC with 35% Fly Ash | 62 | 35 | 0 | 305 | 13 |
| | manufactured according | | | | | |
| | to new invention | | | | | |
| 5 | PSC old technology | 50 | 47 | 30 | 0 | |
| 6 | PSC new technology | 40 | 57 | 0 | 37.5 | 25 |
| 7 | Old Technology | | | | | |
| 8 | New Technology | | | | | |

| | CO2 emission per Mt of | | |
|---|---|---|---|
| | cement production (only | | |
| | based on clinker % in | | |
| | cement, i.e 860 Kg of CO2 | Comparative Total CO2 | |
| | emission per Mt of clinker | emission, based on | |
| | production, without | projected increased | Total CO2 emission |
| | consideration of emission | production of cement, | to produce clinker for |
| | involved to produce final | per annum in million | manufacturing 445 |
| Sr. No. | cement product) (Unit Mt) | tonnes | million tonne of cement |
| 1 | 0.817 | 83.33 | |
| 2 | 0.800 | 81.6 | |
| 3 | 0.602 | 183.6 | |
| 4 | 0.533 | 162.5 | |
| 5 | 0.430 | 16.1 | |
| 6 | 0.344 | 12.9 | |
| 7 | | | 283 |
| 8 | | | 257 |

It is observed that the amount of carbon dioxide produced during the manufacturing of cement according to the present invention is much lesser viz. 257 million tonnes in comparison to the amount produced during the conventional method of cement production viz. 283 million tonnes, clearly showing that the present method is greener and environment friendly (refer FIG. 8), in addition to the surprising physical and chemical properties of cement produced as illustrated in other figures.

1. Method of manufacturing cement, the method comprising:
(a) determining or fixing the highest temperature T° C. that the working mix is expected to reach inside the mill during inter-grinding gypsum (or a dehydrated form thereof) with clinker;
(b) calcining the gypsum at a temperature W° C., such that W>=0.9 T; and
(c) inter-grinding the pre-calcined gypsum with the clinker inside mill such that the highest temperature of working mix inside the mill does not exceed T° C.,
wherein that the change in water of crystallization of gypsum (or a dehydrated form thereof) during inter-grinding with clinker in step (c) is minimal.

2. Method of manufacturing cement as claimed in claim 1, wherein the gypsum is precalcined at a temperature such that more than 50% of gypsum is dehydrated to hemihydrate form [CaSO₄.½H₂O].

3. Method of manufacturing cement as claimed in claim 1, wherein the gypsum is precalcined at a temperature such that more than 80% of gypsum is dehydrated to hemihydrate form [CaSO₄.½H₂O].

4. Method of manufacturing cement as claimed in claim 2, wherein W is about 100° C. to about 120° C.

5. Method of manufacturing cement as claimed in claim 2, wherein T is about 110° C.

6. Method of manufacturing cement as claimed in claim 1, wherein the gypsum is precalcined at a temperature such that more than 50% of gypsum is dehydrated to a form of calcium sulphate with water of crystallization less than 0.5 [CaSO4.nH2O, where 0.5>n>0].

7. Method of manufacturing cement as claimed in claim 1, wherein the gypsum is precalcined at a temperature such that more than 80% of gypsum is dehydrated to a form with water of crystallization less than 0.5 [CaSO4.nH2O, where 0.5>n>0].

8. Method of manufacturing cement as claimed in claim 6, wherein W is about 120° C. to about 160° C.

9. Method of manufacturing cement as claimed in claim 6, wherein T is about 140° C.

10. Method of manufacturing cement as clamed in claim 1, wherein the gypsum is precalcined at a temperature such that more than 50% of gypsum is dehydrated to soluble anhydrite form [CaSO4.nH2O, where 0.05>n>=0].

11. Method of manufacturing cement as claimed in claim 1, wherein the gypsum is precalcined at a temperature such that more than 80% of gypsum is dehydrated to soluble anhydrite form [CaSO4.nH2O, where 0.05>n>=0].

12. Method of manufacturing cement as claimed in claim 10, wherein W is about 160° C. to about 200° C.

13. Method of manufacturing cement as claimed in claim 10, wherein T is about 180° C.

14. Method of manufacturing cement as claimed in claim 1, wherein the gypsum is first ground or pulverized to a size of less than about 75 microns, and preferably to a size 25 less than about 45 microns before being calcined.

15. Method of manufacturing cement as claimed in claim 1, wherein the said pre-calcined gypsum is ground or pulverized to a size of less than about 75 microns, and preferably to a size less than about 45 microns before being inter-grinded with the clinker.

16. Method of manufacturing cement as claimed in claim 1, wherein the inter-grinding of pre-calcined gypsum with clinker is carried out in presence of raw materials selected from the group consisting of fly ash, slag, volcanic ash, rice husk ash, meta kaolin, silica fume, and limestone.

17. Method of manufacturing cement as claimed in claim 16, wherein the fly ash is present in an amount which is more than 25% w/w of the total mix, and preferably 35% w/w of the total mix.
